(19) United States
(12) Patent Application Publication
(10) Pub. No.: US 2026/0068870 A1
(43) Pub. Date: Mar. 12, 2026

(54) BIRD DETERRENT DEVICE

(71) Applicant: LineGuard Products, Marblehead, MA (US)

(72) Inventors: Steven Callahan, Marblehead, MA (US); Scott Bluni, Bethlehem, NH (US); David Bolognia, Lanesborough, MA (US)

(21) Appl. No.: 19/290,156

(22) Filed: Aug. 4, 2025

Related U.S. Application Data
(60) Provisional application No. 63/679,126, filed on Aug. 4, 2024.

(51) Int. Cl. A01M 29/32

(52) U.S. Cl. CPC A01M 29/32

(57) ABSTRACT

Described herein are bird deterrent devices useful for marine and other applications. In various embodiments, the device comprises a housing comprising a first housing portion and a second housing portion connected to the first housing portion. The housing includes a retractable line on a spool, the line extending through an opening extending through a housing side opening. An anchor is attached to the distal end of the line for attachment of the line to a suitable surface.

### RELATED APPLICATIONS

This application claims the benefit of U.S. Provisional Patent Application No. 63/679,126 , filed Aug. 4, 2024, the contents of which are incorporated herein by reference in their entirety.

### BACKGROUND

Gulls and other seabirds are a nuisance to boaters and homeowners in coastal areas. Birds use boat surfaces to hunt for fish, eat their kill, and leave their droppings. Bird droppings on boats can be a significant problem for several reasons. Bird droppings are highly acidic and can cause damage to a boat's paint, gel coat, and metal surfaces. Over time, this can lead to discoloration, corrosion, and deterioration of materials. Bird droppings are unsightly and can make a boat look dirty and poorly maintained. This can be particularly problematic for boat owners who take pride in the appearance of their vessels. Bird droppings can carry diseases and parasites that are harmful to humans. For example, they can harbor bacteria like E. coli and Salmonella, as well as fungi that can cause respiratory issues. Bird droppings can create slippery conditions on decks and walkways, posing a safety hazard to people moving around the boat. Accumulated bird droppings can attract other pests, such as insects, which can further complicate maintenance and cleanliness efforts. Regular cleaning of bird droppings can be time-consuming and labor-intensive, requiring special cleaning products and techniques to effectively remove the acidic waste without damaging the boat's surfaces.

Preventing birds from landing on boats and coastal structures is a challenging task. Conventional deterrents such as plastic owls, reflective tape, or wind-activated spinners often lose effectiveness over time as birds become habituated to them. More sophisticated deterrents, including ultrasonic emitters, bird netting, or electrified tracks, can be costly, require power sources, and may involve complex installation or regular upkeep. Additionally, many existing deterrent systems are bulky, non-collapsible, or difficult to store, making them impractical for use on smaller vessels or during active boating.

There is a need for an improved bird deterrent device for boats and structures in coastal areas that addresses the shortcomings of existing solutions. Such a device should be compact, lightweight, and easy to deploy and stow, without requiring permanent installation or external power. Ideally, the device should be effective at deterring birds without harming them and capable of remaining in place while the boat is underway, thereby offering continuous protection without interfering with normal boating operations.

### DESCRIPTION OF THE DRAWINGS

FIG. 1 is a perspective view of the top side of a bird deterrent device according to a described embodiment.

FIG. 2 is a perspective view of the bottom side of a bird deterrent device according to a described embodiment.

FIG. 3 is an exploded view of a bird deterrent device according to a described embodiment.

FIG. 4 is a perspective view of an anchor element used in a described embodiment.

FIG. 5 is a perspective view of an anchor element according to a described embodiment.

FIG. 6 is an exploded view of a multi-component anchor element according to a described embodiment.

FIG. 7 is a view of a line extending from a housing to form a securement loop.

FIG. 8 is a side view of a bird deterrent device with webbing extended, according to a described embodiment.

FIG. 9 is a cross-sectional, side view of a bayonet element comprising a slot for receiving an attachment element, in accordance with a described embodiment.

FIG. 10 is an exploded view of a bird deterrent device according to a described embodiment comprising two housings.

FIG. 11 is a side view of a line deflection element configured for use with the bird deterrent device, according to a described embodiment.

### DESCRIPTION OF EMBODIMENTS

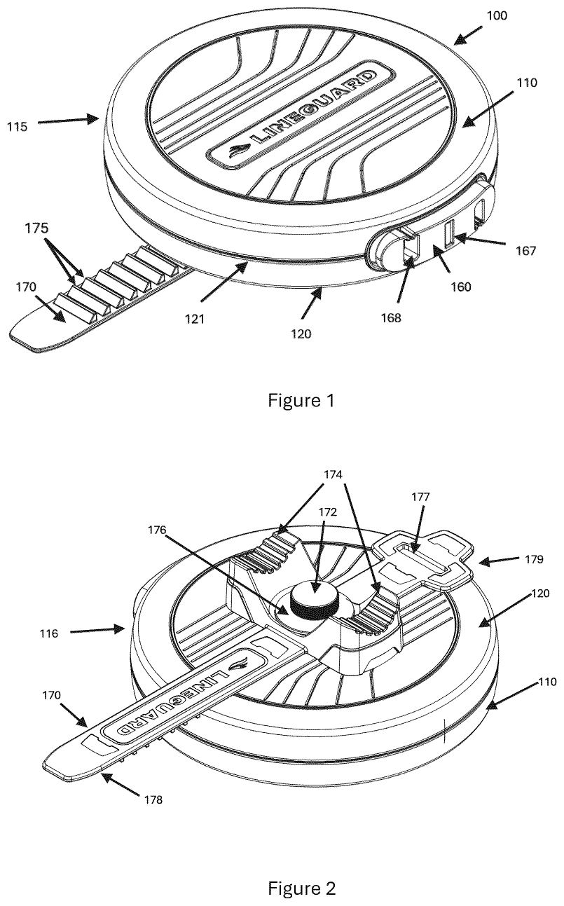

Described herein is a bird deterrent device useful for marine applications. Although embodiments are described with specific reference to use on boats, it should be appreciated that described embodiments are useful as bird deterrent solutions for other structures in coastal areas such as marina structures, house decks, pools, and other structures. In various embodiments, the device comprises a housing 100 comprising a first housing portion 110 and a second housing portion 120 connected to the first housing portion. In embodiments, the first and second housing portions are substantially identical, as shown in FIGS. 1-2. The first and second housing portions form first substantially planar surface 115 and second substantially planar surface 116, respectively, the first and second substantially planar surfaces being substantially parallel to each other. As shown in FIGS. 1-2, the housing 100 includes a side surface 121 formed by side surfaces of the first and second housing portions.

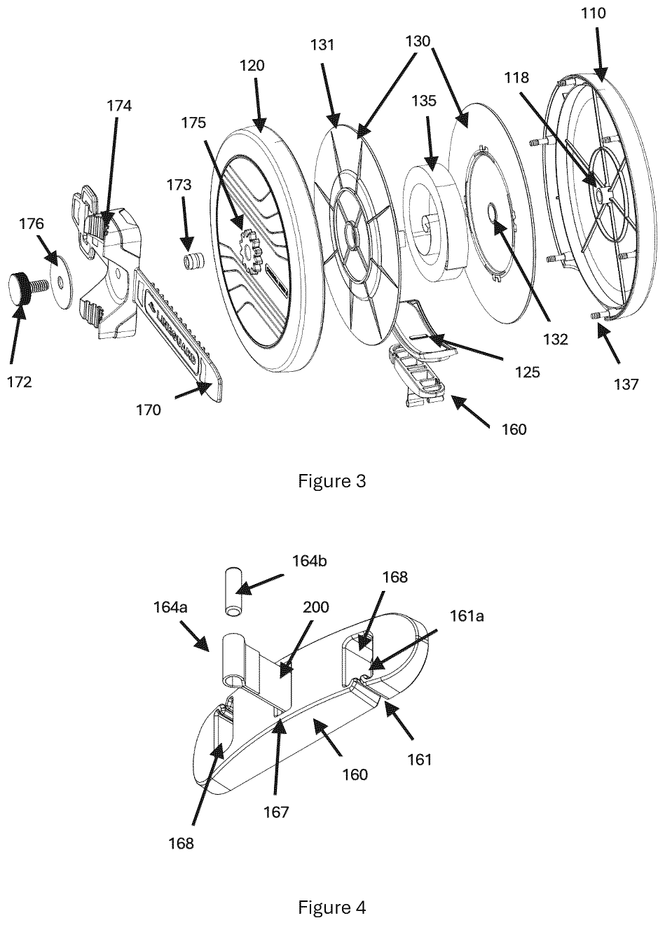

The first and second housing portions are connected together by any suitable means, such as barbed pins 137 as shown FIG. 3. Contained within the housing 100 is a spool 130 having a rim 131 at each end and an axial hole 132 configured to receive a post 118 located in one or both of the first housing portion 110 and second housing portion 120, as shown in FIG. 3. The spool 130 is configured to receive a line 200, which is wound upon the spool 130. Also contained within the housing 100 is a spring 135 connected to the spool 130 and configured to rotate the spool 130 in a first direction. The spring 135 preferably comprises stainless steel to resist corrosion in marine environments. In embodiments, the spring provides a retraction force of at least 0.3, 0.4, 0.5, 0.6, 0.7, 0.8, 0.9, or 1.0 or more pounds to the line 200.

At its proximal end, the line 200 is connected to the spool 130 so that it is automatically wound upon the spool 130 when the spring 135 rotates the spool 130 in a first direction. The line is positioned through opening 125 and is connected to an anchor 160 at its distal end. The anchor 160 is larger than the opening 125 such that the anchor 160 is held against housing 100 by a force exerted on the line 200 by spring 135 acting upon the spool 130, as shown in FIG. 1.

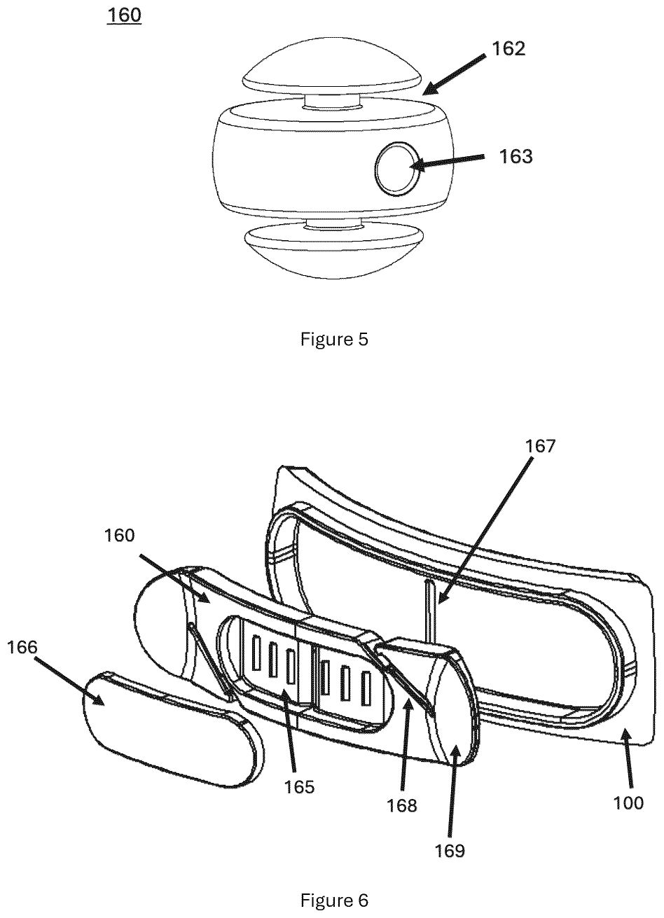

The anchor 160 is of any suitable shape that allows for its function of (1) holding the distal end of line 200 and (2) anchoring the line 200 to an object or surface of a boat, or allowing for the formation of a securement loop towards the distal end of the line 200 for securing around an object on a boat. In an embodiment, the anchor 160 is an elongated member with one or more slots 168 therein extending in a transverse direction to a longitudinal axis of the anchor, as shown in FIG. 4. In this embodiment, anchor 160 includes a central opening 167 to allow for passage of the line 200, which in this embodiment terminates in a loop 164a in which an anchor pin 164b is placed. When pulled taut, the pin 164b slides into the central opening 167 such that the line 200 is held securely within the anchor 160. When not in use, the anchor 160 is held in a resting position against the housing 100 due to the retraction force of the spring acting on the line, as shown in FIG. 1.

To deploy the line for use, a user pulls the anchor 160 away from the housing (which is secured to a boat structure by strap 170 or other securement means, as described below) to create a protected area of a boat by deploying the line 200 around one or more railings, stanchions, fishing rod holders, VHF antennae, cleats, or other boat structure to create a region that is unattractive to birds for landing. For example, the line 200 may be used to create a zig-zag, criss-cross, v-shape, or other suitable design covering substantial portions of a boat structure to form a protected area where birds will be deterred from landing. In the embodiment shown in FIG. 4, the one or more slots 168 each include a side opening 161 so that after covering a desired protective area with the line 200, the user may form a securement loop with the line 200 by placing the anchor 160 around a boat structure to form a loop and then placing the line through the side opening(s) 161 into the one or more slots 168. As such, the line 200 will be held securely in the slots 168 to keep the line 200 deployed in the desired configuration. As shown in the exemplary embodiment of FIG. 4, two slots 168 are used with one on each side of the central opening 167, in which case the slots 168 are placed at a distance from the central opening 167 that allows for a length of line 200 to contact anchor 160 when the line 200 is placed through both slots 168 to form a securement loop. It is believed that such contact may help minimize movement of the anchor 160 relative to the line 160 when deployed as discussed herein. For example, the slots 168 may be spaced 1-2 inches apart from each other, with a spacing of 1.375 inches being preferred. When two or more slots 168 are used, it is preferred that side openings 161 into the slots are formed on alternating sides of the anchor 160, as shown in FIG. 4. Alternatively, two or more slots 168 may be placed on a single side of the central opening 167 or a single slot 168 may be used in anchor 160. In yet another embodiment, an end slot may be used that includes an opening through one of the longitudinal ends of anchor 160. As noted above, any of the anchor slots described herein are configured to receive the line 200 after formation of a securement loop to keep the securement loop in place for the duration of use of the bird deterrent device.

The slots 168 are preferably 0.125-0.375 inches wide to hold the line 200 therein during windy and rough weather conditions. The side openings 161 are preferably 0.016-0.063 inches wide to allow for the passage of the line 200 into the slots 168, and preferably include flared portions 161a at the side opening(s) as a means to help keep the line 200 retained within the slot(s) 168 when deployed.

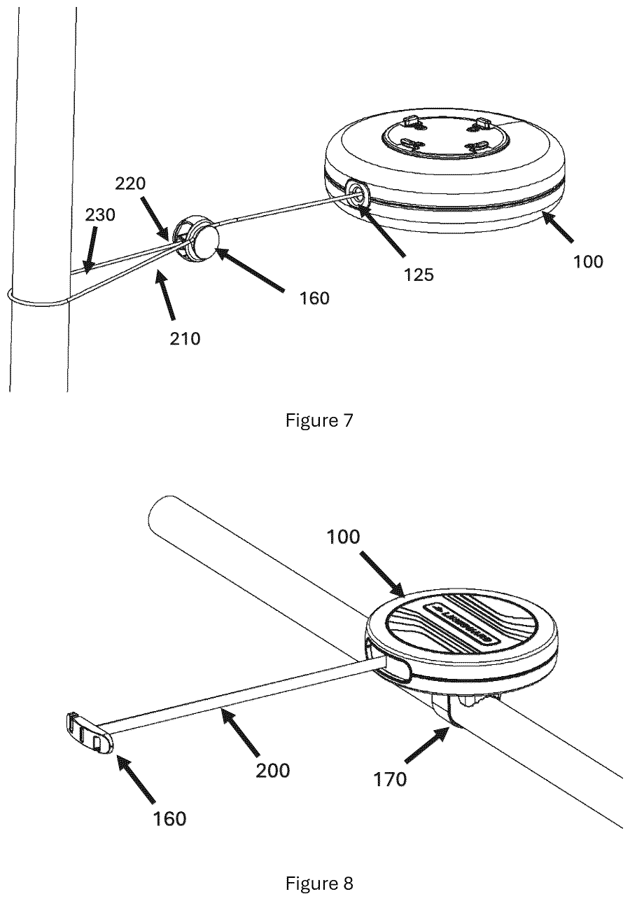

In other embodiments, the anchor 160 is a spherical element having a first attachment point such as a through-hole 163 for receiving the line 200, as shown in FIG. 5. After passing through the through-hole 163, a knot may be made at the distal end of the line 200 to keep it from passing back through the through-hole. The anchor 160 further comprises a second attachment point such as a circumferential notch 162 configured to receive the line 200, which may be wrapped within notch 162 to form a securement loop 230 as shown in FIG. 7. In yet other embodiments, the anchor 160 is a multi-component elongated member as shown in FIG. 6, which includes an attachment component 166 to which a line is attached, and a seat component 165 in which the attachment component is seated. In this multi-component embodiment, the seat component 165 includes an opening 167 through which the line 200 passes to connect to the attachment component 166. When configured as an elongated member, anchor 160 preferably includes one or more slots 168 for receiving line 200 to form a securement loop 230. As shown in FIG. 6, the slots used in various embodiments may be angled relative to a longitudinal axis of the anchor 160. When configured as an elongated member, anchor 160 optionally includes one or more flared portions 169 at the ends thereof which can be pressed to quickly separate an opposing portion of the anchor 160 from the housing 100 for ease of handling. It should be appreciated that the anchor 160 may be any other suitable size, shape, and configuration.

The line 200 may be of any suitable length, thickness, and color. Preferably, the line 200 includes a reflective material to enhance visibility. Preferably, the length of the line is at least 20 feet, more preferably at least 30 feet, more preferably at least 40 feet, and more preferably at least 50 feet. The line should be of sufficient length to create a protective area over a desired area of a boat such as a bow region, a foredeck, a hardtop, a pilot house, an aft deck, a stern region, or a swim platform, for example. The line 200 is any suitable element that can be extended and retracted within housing 100, and may be configured as a line (as shown in FIG. 7), cord, cable, webbing (as shown in FIG. 8), ribbon, tape, or the like, all of which are referred to herein as a line. Webbing is generally a preferred line material as it creates a high surface area relative to other line material alternatives, making it generally more visible to birds and causing more movement in windy conditions, which in turn increases its deterrent effect. In a preferred embodiment, the line is a webbing approximately 0.250-0.50 inches in width, preferably 0.375 inches in width, and 0.020-0.024 inches in thickness.

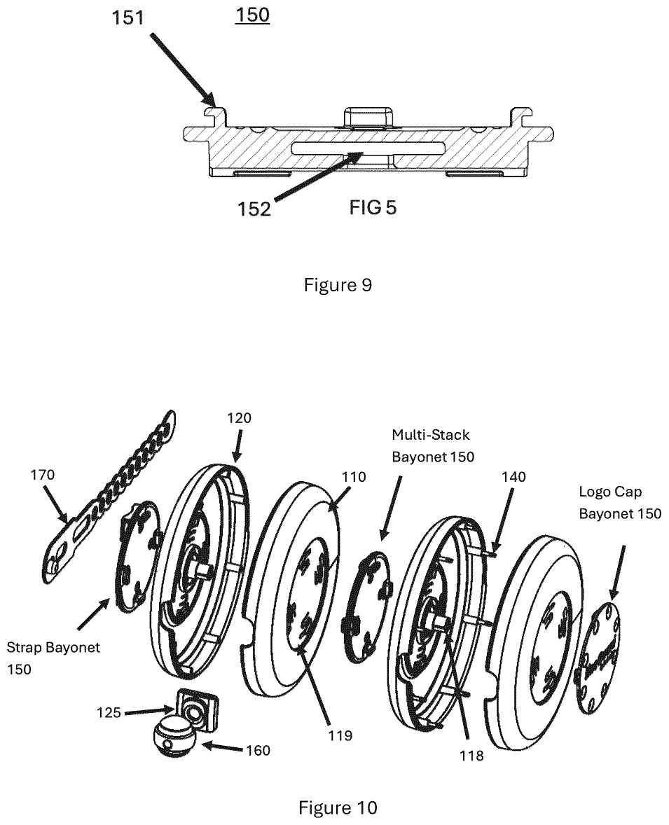

In embodiments, one or both of first planar surface 115 and second planar surface 116 have a bayonet element 150 removably attached thereto. In embodiments, the bayonet element 150 is a disc-shaped member comprising one or more tabs 151 extending from a surface thereof as shown in FIG. 9 for interfacing with receiving openings 119 within first and second housing portions 110, 120, as shown in FIG. 10. The tabs 151 and receiving openings 119 may be configured such that bayonet is removably attached to the housing 100 by alignment of the tabs 151 and receiving openings 119 such that the tabs 151 extend through the housing portion, and subsequent rotation of the bayonet element 150 to hold at least a portion of the tabs 151 on the opposite side of the bayonet element 150.

The optional bayonet element 150 is configured based upon its intended purpose. In an embodiment shown in FIG. 9, the bayonet element 150 comprises an opening 152 for receiving an attachment element configured to attach the housing to a support structure, such as the elastomeric strap 170 placed through the opening 152 as shown in FIG. 1. The elastomeric strap 170 is made from any suitable material, such as silicone or a thermoplastic elastomer. The elastomeric strap 170 is preferably made from silicone having a durometer of approximately Shore 60D. In other embodiments, the bayonet element 150 comprises other attachment elements for attaching the housing 100 to a boat structure, such as one or more suction cups or hook-and-loop fastener surfaces such as VELCRO^{→} (Velcro IP Holdings LLC). In still other embodiments, the bayonet element 150 comprises tabs 151 on both planar surfaces thereof to facilitate attaching two housings to each other, as shown in FIG. 10 (denoted as a Multi-Stack Bayonet).

In some embodiments, one or more attachment elements for attaching the housing 100 to a boat structure are attached directly to the housing rather than to a bayonet element. For example, the embodiment shown in FIG. 1 make use of a strap 170 that is attached directly to first or second housing portions 110, 120. The strap 170 is attached to the housing by any suitable means, such as by a threaded screw 172 that interfaces with a threaded insert 173 located within the housing. In embodiments, the threaded insert 173 is surrounded by a locking member 175 protruding from the surface of the housing and configured to interface with the strap 170. For example, in the embodiment shown in FIG. 3, the locking member 175 is a protruding cog-shaped element that interlocks with a corresponding recessed area within strap 171, resulting in the ability to hold the strap 170 in various fixed orientations relative to the housing. A washer 176 may be placed between the strap 170 and the threaded screw 172 to help secure the strap 170 against the housing. In embodiments, the strap 170 includes one or more shoulder portions 174 configured to interface with an attachment point on a boat, such as a boat railing, cleat, or the like. The one or more shoulder portions 174 are optionally shaped as a semi-circle, optionally with a ribbed surface, for interfacing and gripping the attachment point. In embodiments, the strap 170 includes a first portion 178 having a first width configured to slide through an aperture 177 in a second portion 179 to create a loop for secure the housing 100 to the attachment point. In an embodiment, the second portion 179 is thicker in a portion surrounding the aperture 177 relative to the remaining portions of the strap 170. The first portion 178 optionally includes raised features 175 that are configured to slide through the aperture 177 but provide desired resistance against sliding back through the aperture 177 after the housing is secured to a boat structure. The raised features 175 are preferably triangular in cross section to facilitate easy movement in one direction through the aperture 177 but resistance against the aperture 177 in the opposite direction. The strap 170 can therefore be “locked” to a desired tightness around an attachment point.

To use the bird deterrent device, the housing 100 is attached to a structure on the outer surface of a boat, such as a deck, hardtop, glass surface, railing, stanchion, fishing rod holder, VHF antenna, cleat, or other structure with one or more suitable attachment elements, as shown in FIG. 8. An increment of line 200 is then extended from the housing 100 by pulling the anchor 160 in any direction away from the housing 100, as shown in FIG. 8. For example, the housing may be attached to a bow rail on the starboard side of a boat, and the line pulled to the port side and back to the starboard side in a zig-zag fashion to form a protective area. When the line has been fully positioned, a securement loop 230 is formed around any structure on the boat by attaching the anchor to a portion 210 of the line that is proximal of the distal end 220 of the line as previously described. After use, the securement loop 230 is disassembled by removing the line 200 from slots 168, notch 162, or other attachment means within the anchor 160, and the line 200 is retracted into housing 100 due to the retraction force applied by the spring 135. The housing 100 is then detached from its attachment point on the boat and stowed for future use.

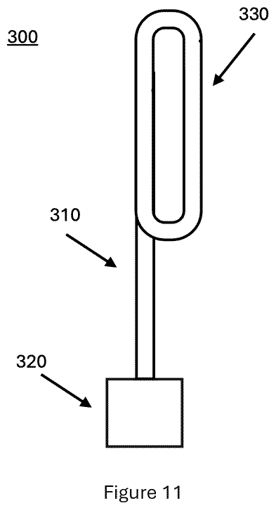

In an embodiment, the bird deterrent device is included in a kit that also includes a line deflection element 300, as shown in FIG. 11. In an embodiment, the line deflection element 300 includes a hook portion 310 attached to a base portion 320. The hook portion 310 terminates in an end section 330 configured to hold a segment of the line 200 when passed through it. For example, the end section 330 may be configured as a closed circular or ovular shape as shown in FIG. 11 provided that the opening of the circular shape allows for passage of the anchor 160 through it. In embodiments, the end section 330 is “J” shaped with an open end rather than having a closed end. The base portion 320 comprises any suitable shape or mechanism to attach the line deflection element 300 to a surface, such as a VHF antenna, boat deck, hardtop, or the like. In embodiments, the base portion 320 comprises a suction cup, a hook-and-loop fastener surface, a clamp mechanism, or the like.

The embodiments described herein are compact, lightweight, and easy to deploy and stow, without requiring permanent installation or external power. The described embodiments are effective at deterring birds without harming them and capable of remaining in place with the line retracted while the boat is underway, thereby offering continuous protection without interfering with normal boating operations

1. A bird deterrent device, comprising:
a housing comprising a first housing portion and a second housing portion connected to the first housing portion, the first housing portion forming a first planar surface and the second housing portion forming a second planar surface substantially parallel to the first planar surface, the housing having a side surface with at least one opening extending therethrough;
a spool contained within the housing;
a spring connected to the spool and configured to rotate the spool in a first direction;
a line extending through the opening and having a proximal end and a distal end, the proximal end connected to the spool; and
an anchor attached at a first attachment point to the distal end of the line;
wherein an increment of the line is configured to be advanced out of the housing through the opening by pulling the anchor in a direction away from the housing.

2. The device of claim 1, wherein the anchor comprises an elongated structure with at least one slot extending in a direction transverse to a longitudinal axis of the anchor.

3. The device of claim 1, wherein the anchor comprises a spherical element comprising a circumferential notch extending along a plane intersecting the spherical element.

4. The device of claim 3, wherein the spherical element comprises a through hole configured to receive the line.

5. The device of claim 1, further comprising an elongated strap removably attached to the housing.

6. The device of claim 5, wherein the elongated strap comprises a first portion configured to slide through an aperture slot in a second portion of the strap.

7. The device of claim 6, wherein the first portion comprises at least one raised feature configured to slide through the aperture in the second portion.

8. The device of claim 7, wherein the elongated strap comprises one or more shoulder portions configured to interface with an attachment point on a boat.

9. The device of claim 1, wherein at least one of the first housing portion and second housing portion comprise a bayonet element removably attached to the planar surface of the at least one of the first housing portion and second housing portion.

10. The device of claim 9, wherein the bayonet element includes a lateral protrusion comprising a slot for receiving an attachment element configured to attach the housing to a support structure.

11. The device of claim 9, wherein the bayonet element comprises at least one suction cup configured to attach the housing to a support surface.

12. The device of claim 9, wherein the bayonet element is configured to attach the housing to a second housing substantially identical to the housing.

13. The device of claim 1, wherein the line comprises a webbing structure.

14. The device of claim 13, wherein the webbing has a thickness of at least 0.375 inches.

15. The device of claim 14, wherein the line is at least 25 feet in length.

16. The device of claim 1, wherein each of the first and second housing portions comprise a plurality of pin housings, each pin housing configured to house a pin to connect the first housing portion to the second housing portion.

17. The device of claim 1, wherein the anchor is configured to attach at a second attachment point to a portion of the line that is proximal of the distal end of the line to form a loop at a distal portion of the line.

18. A kit comprising the device of claim 1.

19. The kit of claim 15, further comprising a line deflection element comprising a hook attached to a base, wherein the hook is configured to hold a portion of the line.

20. The kit of claim 16, wherein the base comprises a suction cup.
